(19) United States
(12) Patent Application Publication
(10) Pub. No.: US 2018/0105050 A1
(43) Pub. Date: Apr. 19, 2018

(54) Actuation Device

(71) Applicant: Stäubli Electrical Connectors AG, Allschwil (CH)

(72) Inventors: Christian Hengel, Hochstatt (FR); Louis Delorenzi, Blodelsheim (FR); Laurence Lombardo, Didenheim (FR)

(21) Appl. No.: 15/565,266

(22) PCT Filed: Apr. 6, 2016
(86) PCT No.: PCT/EP2016/057487

§ 371 Date: Oct. 9, 2017

(30) Foreign Application Priority Data
Apr. 10, 2015 (EP) 15163188.4

(51) Int. Cl. B60L 11/18; H01R 13/631; H01R 43/26

(52) U.S. Cl. CPC B60L 11/1818; B60L 11/1827; H01R 13/4538; H01R 43/26; B60L 2230/12; H01R 13/6315

(57) ABSTRACT

An actuation device for a connector includes a mounting element and an arm extending along an arm axis. The arm has a front section with a connection interface configured to receive the connector, a rear section and a bearing section between the front section and the rear section. The actuation device also includes a pivot element which is in connection with the bearing section of the arm and with the mounting element so as to connect the arm pivotably to the mounting element. The pivot element includes a pivot axle. A balance element is connected to the rear section of the arm and is configured to balance the arm regarding a movement around the pivot axle.

### TECHNICAL FIELD

The present invention relates to an actuation device for a connector according to the preamble of claim 1 and a connection system according to the preamble of claim 14.

### PRIOR ART

From EP 2 393 165 a charging connector has been disclosed. Such a connector can be used for example in the field of electrical mobility in order to charge batteries of a vehicle. According to EP 2 393 165 it is possible to compensate a slight angular misalignment between the connector and the receiving opening in which the connector shall extend.

### SUMMARY OF THE INVENTION

It is an object of the present invention to provide an actuation device for a connector which actuation device shall have enhanced alignment properties. In particular the actuation device shall be provided for a connector according to EP 2 393 165 or any other suitable connector.

Such an object is solved by the actuation device according to claim 1. Accordingly an actuation device for a connector comprising
a mounting element,
an arm extending along an arm axis, which arm has a front section with a connection interface configured to receive the connector, a rear section and a bearing section between said front section and said rear section,
a pivot element which is in connection the bearing section of the arm and with the mounting element so as to connect the arm pivotable to the mounting element, wherein the pivot element comprises a first pivot axle allowing a pivot movement around a first axis and a second pivot axle allowing a pivot movement around a second axis, wherein said first axis and said second axis are perpendicular to each other,
and
a balance element which is connected to or provided at the rear section of the arm configured to balance the arm regarding a movement around at least one of said pivot axle.

With such a structure it becomes possible to orient the arm with regard to the external element to which the arm with the connector shall be oriented in a facile manner. The actuation device has due to the arrangement of the pivot element enhanced alignment properties.

Preferably the actuation device further comprises at least one longitudinal guiding element extending in direction of a longitudinal axis and said mounting element is a sliding element which is in a connection with the longitudinal guiding element such that the sliding element is slideable relative to said longitudinal guiding element or by means of said longitudinal guiding element in direction of said longitudinal axis. Preferably said first axle and/or said second axle are perpendicular to the longitudinal axis.

In one variant the longitudinal guiding element is a stationary profile in which guide rollers that are connected to the sliding element can move. In a further variant the longitudinal guiding element is a telescopic guide to which the sliding element is connected. Other variants are also possible.

In summary there are two preferred embodiments. In one embodiment the mounting element is provided as fixed structure. In a further embodiment the mounting element is provided as sliding element and can be moved along the longitudinal guiding element.

The arrangement at the rear section means that the balance element is arranged on the other side of the front section with regard to the pivot axle.

According to said one embodiment the actuation device comprises at least the mounting element, the arm, the pivot element and the balance element. According to said further embodiment the actuation device comprises at least the at least one longitudinal guiding element, the sliding element, the arm, the pivot element and the balance element.

Due to the connection of the arm via said pivot element to the sliding element which can be moved along the longitudinal axis of the longitudinal guiding element it becomes possible to move and orient the connector, that is connected to the front section of the arm in an efficient manner. In particular it becomes possible to orient the arm with its arm axis such that the arm axis is angular to the longitudinal axis.

Furthermore the balance element serves to balance the arm as it compensates the weight provided by the front section and the connector. The balance element can also be designated as balance weight. In other words: It serves to hold the arm in balance regarding a pivot movement that is enabled by the pivot element. The balance element compensates therefore the weight of the arm of the front section. Due to the balance element the balance of the arm can be maintained during the use, i.e. in the initial position as well as in a connection position in which the arm is pivoted or in which the arm is pivoted and the sliding element has been moved along the longitudinal axis.

The balance element can be provided as separate element which is connected to the arm or it can be an integral part of the arm.

As mentioned above the connection interface to which the connector is mounted to the arm is part of the arm. In particular it is part of the front section or it can be provided by the front section.

The arm can be moved from an initial position in which the connector is not connected to said external device to a connection position in which the arm is moved towards an external device, such as a car or a bus, in order to establish an electrical contact with the external device via the connector. The actuation device can also be part of the car or the bus. In the embodiment with the mounting element the arm axis is in the initial position parallel to the longitudinal axis. In the connection position the arm axis is pivoted with regard to the longitudinal axis around said pivot element. In the embodiment with the sliding element the arm axis is parallel to the longitudinal axis and the sliding element is located at the rear end of the longitudinal guiding element in the initial position. In the connection position the sliding element has been slide towards and is located at the front end of the longitudinal guiding element and the arm axis is pivoted with regard to the longitudinal axis around said pivot element.

In use the first pivot axle is preferably perpendicular to the horizontal and the second axis is then parallel to the horizontal.

Preferably the first pivot axle and the second pivot axle are arranged at a distance to each other such that the axles do not intersect with each other's. Even more preferably the first pivot axle and the second pivot axle are arranged such that the first axis and the second axis intersect with the longitudinal axis.

The first pivot axle can be provided as continuous axle or it can be provided as interrupted axle. The same applies to the second pivot axle.

Preferably the balance element has a weight which allows balancing between the front section and the rear section around said bearing section. This means that the torque provided by the weight of the rear section and the balance element around the bearing section is equal to the torque as provided by the front section and the attached connector. Hence it is preferable to choose the balance element based on the connector to be attached.

Preferably each of the pivot axles are connected to a tension unit providing a tension force in order to maintain the arm in an initial position or to move the arm back to the initial position. In the initial position the arm axis is oriented perpendicular to the longitudinal axis. The tension unit can be for example provided by tension springs which act on the pivot axles such that the force provided by said tension springs has to be overcome in order to pivot the arm.

Preferably each of the pivot axles are connected to a damper unit providing a damping force against a movement of the arm around said first and second axis. With the damper unit the speed of the movement of the arm can be slowed down.

Preferably exactly two longitudinal guiding elements are arranged parallel and at a distance to each other.

Preferably the at least one longitudinal guiding element is arranged stationary and the sliding element, the arm with the balance element and the pivot element can be moved relative along said longitudinal axis to the at least one longitudinal guiding element. Due to the pivot element it becomes further possible to orient the arm and therefore also the connector angularly to the longitudinal axis as mentioned above. In other words: The arm will be pivoted relative to the longitudinal axis.

Preferably the longitudinal guiding element has the shape of U-Profile.

Preferably the sliding element comprises for the or for at least one of the longitudinal guiding element at least two guide rollers, wherein said guide rollers interact with said longitudinal guiding element. The guide rollers are arranged at a distance to each other. Due to the arrangement of two guide rollers the orientation of the sliding element to the longitudinal guiding element can be maintained.

In a preferred embodiment there are two longitudinal guiding elements, one sliding element as well as on the one side of the sliding element towards the longitudinal guiding element at least two guide rollers and on the other side of the sliding element towards the longitudinal guiding element at least one guide roller. Therefore the sliding element is in connection with the longitudinal guiding element via at least three guide rollers. However, it is also possible to arrange two guide rollers per longitudinal guiding element so that in case two longitudinal guiding elements are present at least four guide rollers are arranged.

Preferably the pivot element further comprises a support structure. The support structure serves to provide a link between the arm and the mounting element or said sliding element, respectively via said pivot axles. Said support structure is via said first pivot axle in connection with said mounting element or said sliding element, respectively such that the support structure is pivotable around the first axis with regard to the mounting element or the sliding element, respectively. The mounting element is arranged such that it is fixed.

The sliding element is, as mentioned above, preferably arranged such with regard to the longitudinal guiding element that only a movement along the longitudinal axis is allowed, but no pivot motion with regard to the longitudinal axis. Further said bearing section of the arm is via said second pivot axle in connection with said support structure such that the bearing section is pivotable around the second axis with regard to the support structure.

In other words: The support structure can be pivoted around the first pivot axle with regard to the longitudinal guiding element and the mounting element or the sliding element, respectively. Due to the contact via the second pivot axle with the bearing section of the arm, the arm will also be pivoted to the longitudinal guiding element and the mounting element or the sliding element, respectively. Furthermore the bearing section of the arm that is in pivotable connection with the support structure can be pivoted to the support structure which—as just mentioned—can be pivoted relative to the mounting element or to the longitudinal guiding element and the sliding element. This leads to a pivot motion of the arm around said two axles.

Preferably said first pivot axle is pivotably mounted in a pivot bearing and fixedly mounted in a fixed bearing, which pivot bearing is part of the support structure and which fixed bearing is part of the mounting element or said sliding element, respectively or which pivot bearing is part of the mounting element or said sliding element, respectively and which fixed bearing is part of the support structure.

The second pivot axle can be arranged similarly: Preferably said second pivot axle is pivotably mounted in a pivot bearing and fixedly mounted in a fixed bearing, which pivot bearing is part of the support structure and which fixed bearing is part of the bearing section of the arm or which pivot bearing is part of the bearing section of the arm and which fixed bearing is part of the support structure.

Preferably the tension unit and/or the damper unit is/are preferably arranged in connection with the pivot bearings. Hence said units are connected to the pivot axles at the location of the pivot bearings.

Preferably the longitudinal guiding element is part of a frame comprising fixing elements configured to fix the frame to an external element. The frame can be covered by a housing or it can be part of a housing.

Preferably a channel extends through the balance element and the arm, which channel is configured to receive a cable supplying energy to the connector. Hence the cable can be guided in a hidden manner through the arm.

Preferably a flexible cable guiding element is connected to the rear section of the arm in the vicinity of the channel. Therefore the cable can be guided in a safe manner to the channel. In a further embodiment it may also be possible to have more than one, in particular two, cable guiding elements, whereby it is preferable to arrange one of which on each side of the arm.

Preferably actuation device further comprises an actuator which acts on said sliding element in order to move the sliding element along the longitudinal axis. The actuator is preferably a linear motor or it can be a motor acting on a belt transmission.

A connection system comprising an actuation device according to the description above and an electrical connector which is connected to the front section of said arm.

In a preferred embodiment the connector is arranged according to the connectors as disclosed in EP 2 393 165.

Preferably the connector comprises a contact section configured to be received by socket and a deflection section configured to compensate an angular misalignment between the contact section and the socket. The deflection section lies between the contact section and the arm.

The deflection section allows a slight deflection. The degree of deviation to the longitudinal axis as provided by the pivot element is larger than the degree of deviation to the longitudinal axis as provided by the deflection section. In other words: the pivot element serves to take over the large deviation, whereas the deflection element serves to take over a small deviation.

Further embodiments of the invention are laid down in the dependent claims

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a perspective view of an actuation device according to an embodiment of the present invention in its initial position;

FIG. 2 shows a view of the actuation device according to FIG. 1 in its connection position;

FIG. 3 shows a top view of a part of the actuation device according to FIG. 1;

FIG. 4 shows a further view of the actuation device according to FIG. 1 in its connection position;

FIG. 5 shows a sectional view of the actuation device according to FIG. 1 through the pivot axles; and

FIG. 6 shows a perspective view of an actuation device according to FIG. 1, with a different longitudinal guiding element.

### DESCRIPTION OF PREFERRED EMBODIMENTS

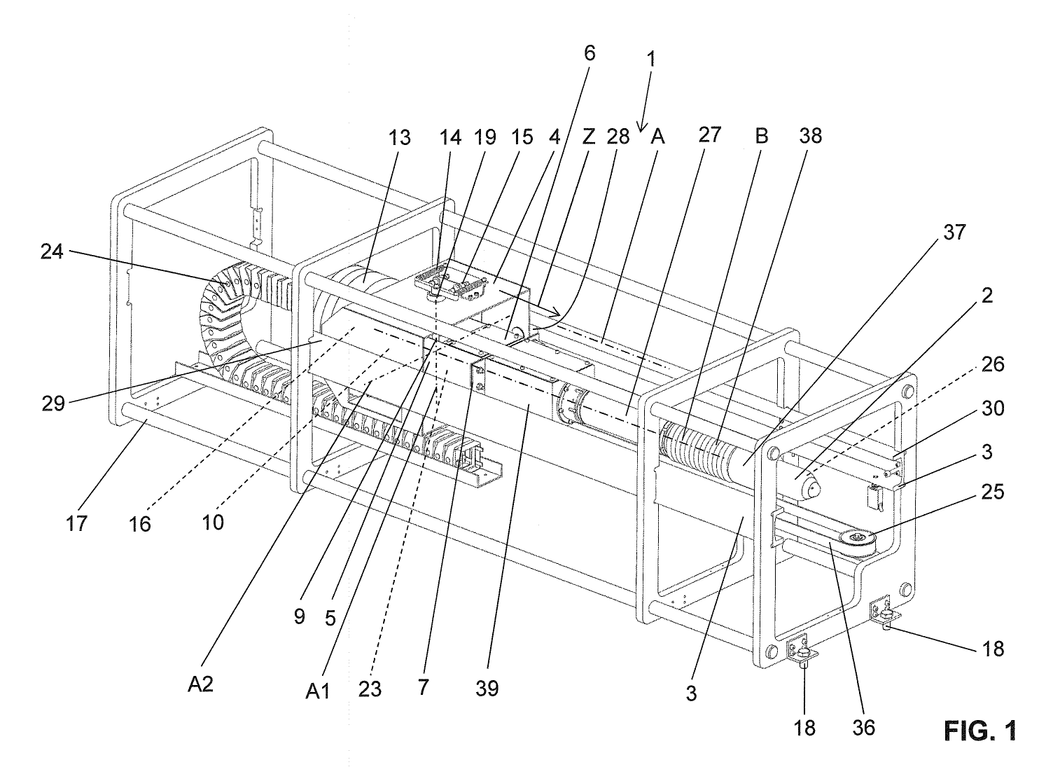

In the FIGS. 1 to 5 there is shown an actuation device 1 with a connector 2 according to one possible embodiment of the present invention. The actuation device 1 can be used to move the connector 2 with regard to a corresponding connection element of an external moveable device such as a car or a bus.

In an embodiment not shown by the figures the actuation device 1 for a connector 2 comprises a mounting element 4, an arm 5, a pivot element 10 and a balance element 13. The actuation device 1 can be part of a connection system which comprises apart from the actuation device 1 also the connector 2.

In the embodiment shown in the figures the actuation device 1 for a connector 2 comprises at least one longitudinal guiding element 3, a mounting element in the shape of a sliding element 4, an arm 5, a pivot element 10 and a balance element 13. The actuation device 1 can be part of a connection system which comprises apart from the actuation device 1 also the connector 2.

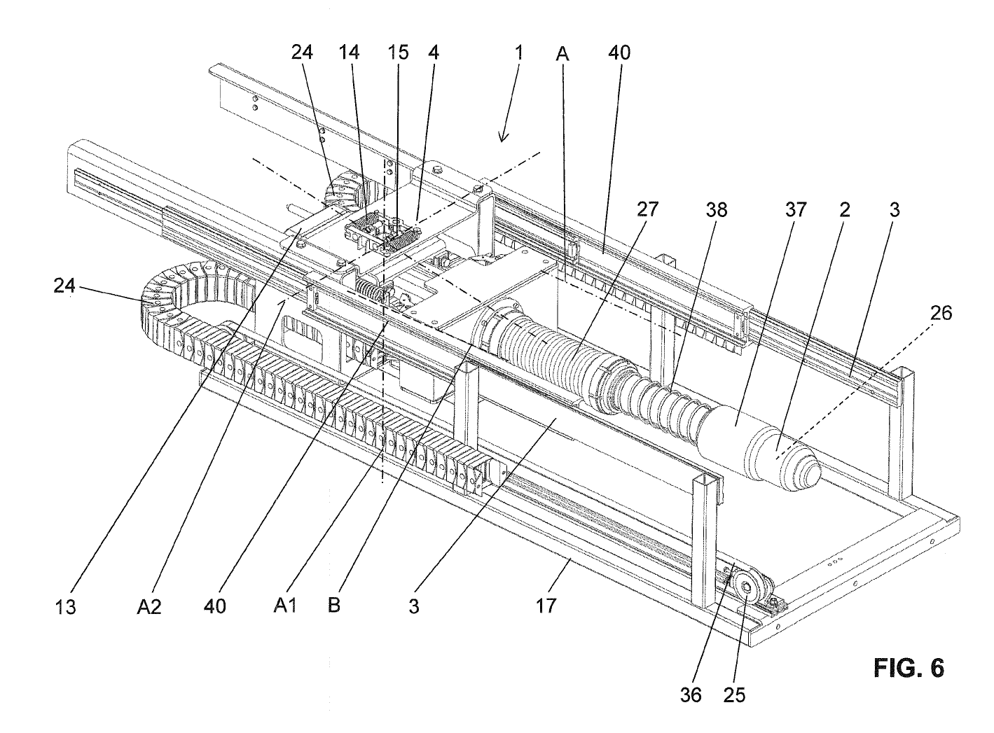

The at least one longitudinal guiding element 3 extends in direction of a longitudinal axis A. In the present embodiment two longitudinal guiding elements 3 are arranged with a distance to each other. Both longitudinal guiding elements 3 extend parallel to each other. The longitudinal guiding elements 3 have in the present embodiment according to FIGS. 1 to 5 the shape of a U-profile. In a different embodiment according to FIG. 6 the longitudinal guiding elements 3 have the shape of telescopic guides 40.

The mounting element, which is shown as sliding element 4 in the figures, is in connection with the at least one, here with both, longitudinal guiding elements 3, such that the sliding element 4 is slideable relative to said longitudinal guiding element 3 in direction of said longitudinal axis A. The sliding element 4 is therefore moveable relative to the longitudinal guiding elements 3. The longitudinal guiding elements 3 are arranged stationary. In the present embodiment the sliding element 4 is connection with guide rollers 28 as it will be further described below. The guide rollers 28 work together with the longitudinal guiding elements 3 and therefore the sliding element 4 can be moved relative to the longitudinal guiding elements 3. In the variant of FIG. 6 the mount element 4 is firmly connected to the telescopic guides 40. Parts of the telescopic guides 40 are arranged stationary With regard to FIG. 1 or 6 this means that the sliding element 4 can be moved along the longitudinal axis A as it is shown by arrow Z.

The arm 5 extends along an arm axis B. The arm axis B is in the initial position parallel with the longitudinal axis A. In use, as it is explained further below, the arm axis B is pivoted with regard to the longitudinal axis A. The arm comprises a front section 6 with a connection interface 7 configured to receive the connector 2, a rear section 8 and a bearing section 9. The bearing section 9 is arranged between the front section 6 and the rear section 8. In all the figures the connector 2 is shown in a mounted stage with the connection interface 7. The connector 2 is connected to the front section 6 via the connection interface 7.

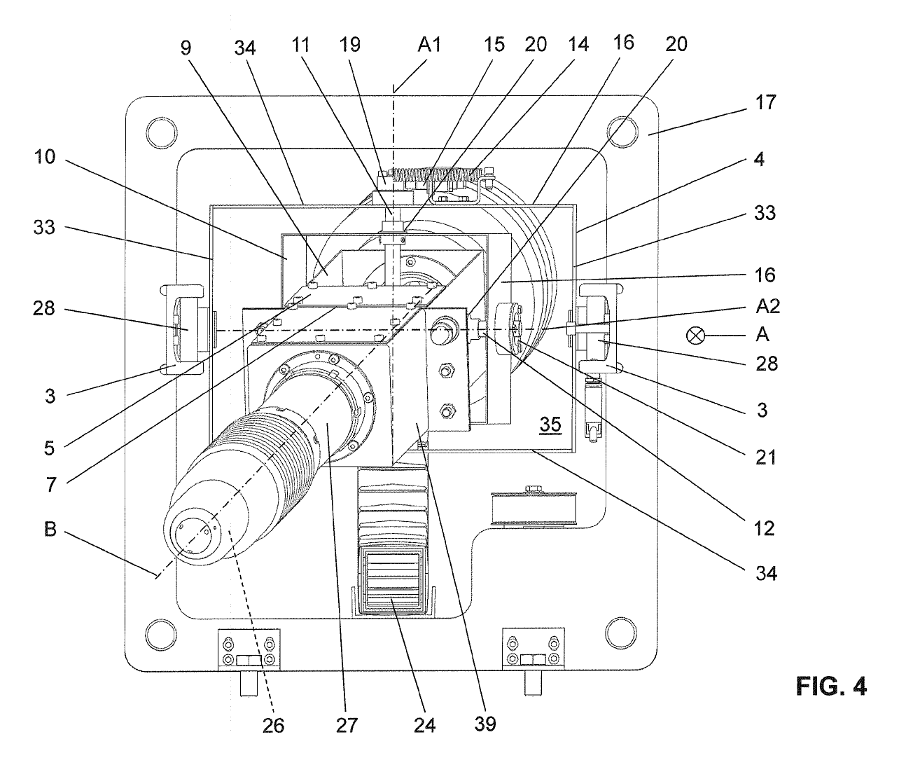

The pivot element 10 is in connection with the bearing section 9 of the arm 5 and with the sliding element 4 so as to connect the arm 5 in a pivotable manner to the sliding element 4. With the pivot element 10 the arm 5 is therefore pivotable to the sliding element 4, which itself is only moveable along the longitudinal axis A but cannot be pivoted to the longitudinal axis A. The pivot element 10 comprises, as it will be outlined further below with regard to FIG. 4, a first pivot axle 11 allowing a pivot movement P around a first axis A1 and a second pivot axle 12 allowing a pivot movement P′ around a second axis A2. Said first axis A1 and said second axis A2 are perpendicular to each other. Furthermore said first axis A1 and said second axis A2 are perpendicular to the longitudinal axis A.

In the embodiment not shown in the figures the pivot element is connected to the mounting element in a similar manner.

The balance element 13 is connected to the rear section 8 of the arm 5. Thereby the balance element 13 is configured to balance the arm 5 regarding a pivoting movement around at least one of said pivot axles 11, 12. With other words the balance element 13 compensates the torque as it is provided by the front section 6 of the arm 5 as well as by the connector 2. With the balance element 13 the arm 5 can be balanced in its initial position and also during the above mentioned pivot movement. The balance element 13 has a weight which allows balancing between the front section 6 and the rear section 8 around said bearing section 9 or said pivot element 10.

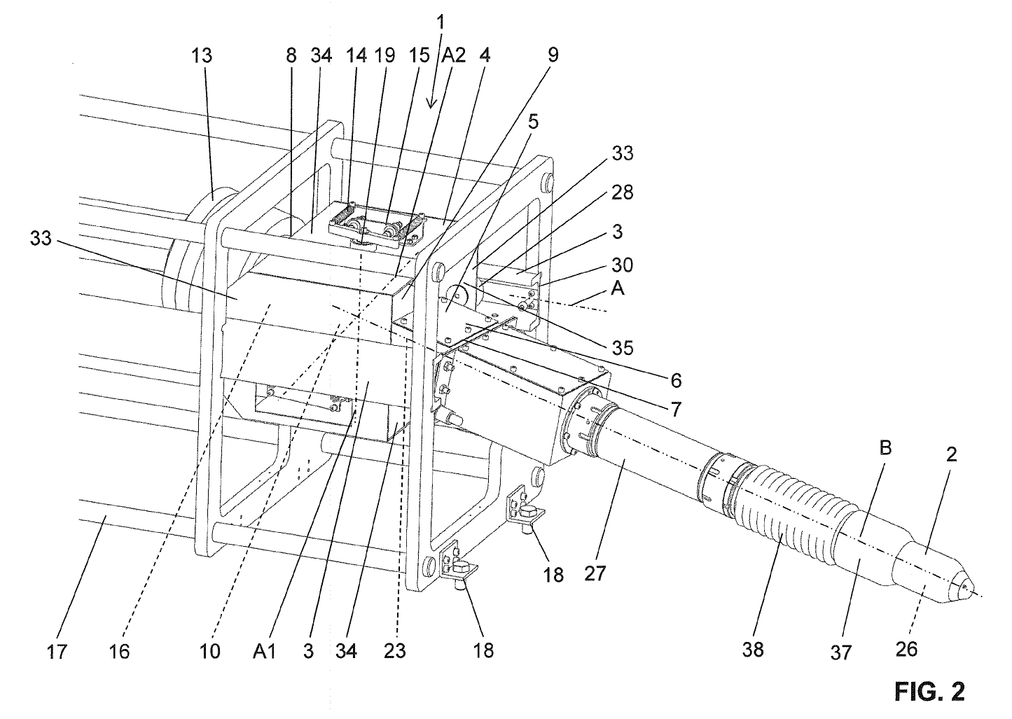

The arm 5 can be moved from an initial position in which the connector is not connected to said external device to a connection position in which the arm 5 is moved towards the external device in order to establish an electrical contact with the external device via the connector 2. In FIG. 1 the arm 5 with the connector 2 is shown in the initial position. In the initial position the arm axis B is parallel to the longitudinal axis A and the sliding element 4 is located at the rear end 29 of the longitudinal guiding element 3. In FIG. 2 the arm 5 and the connector 2 are shown in their connection position. The sliding element 4 has been slide towards and is located at the front end 30 of the longitudinal guiding element 3 and the arm axis B is pivoted with regard to the longitudinal axis A around said pivot element 10. From FIG. 2 it becomes evident that the connector 2 can be oriented according to the location of the external device, which can be—as mentioned above—a plug side of an electrically driven vehicle, such a car or a bus.

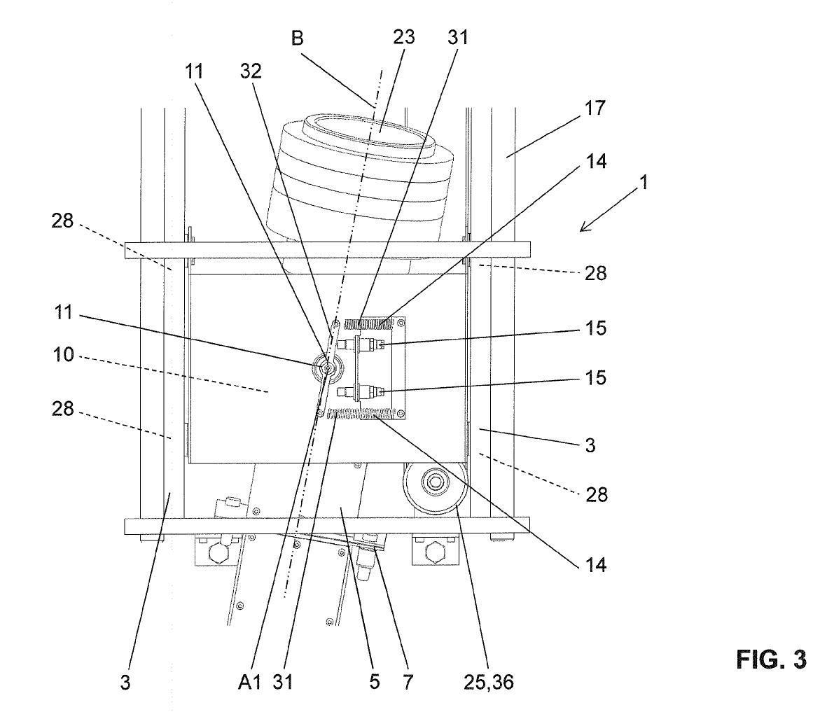

FIG. 3 shows also the situation in the connection position. Furthermore from FIG. 3 it can be recognized that there is a tension unit 14 arranged. The tension unit 14 is provided to provide a tension force on the respective pivot axle 11, 12. The tension unit 14 comprises in the present case two springs 31 which act on the respective pivot axle 11, 12. The pivot axle 11, 12 comprises here a lever 32 extending radially to the respective axis A1, A2. At the end portion of the lever 32 the springs 31 act on said lever 32. The lever 32 is connected in a fixed manner to the respective pivot axle 11, 12. In case the pivot axle 11, 12 will be pivoted around its axis A1, A2 one of the springs 31 will be compressed and the other of the springs 31 will be extracted. Thereby a tension force can be provided on the pivot axle 11, 12 in order to maintain the arm 5 in the initial position.

Also from FIG. 3 it can be seen that a damper unit 15 is arranged. The damper unit 15 provides a damping force against the movement of the arm 5. The damper unit 15 act in the present case also on the lever 32.

In the present case examples of the tension unit 14 and the damper unit 15 are shown. It is however clear that the tension unit 14 and the damper unit 15 can also be provided in a single piece providing the same function. The main issue is to provide said tension force and said damping force against a movement of the arm around the first or the second axis, A1, A2.

FIG. 4 shows a front view of the actuation device 1 with the connector 2 in the connection position. In this figure it can be clearly seen that the arm axis B is no longer parallel with the longitudinal axis A.

From the view of FIG. 4 it can be seen that the sliding element 4 comprises guide rollers 28. The guide rollers 28 engage with the longitudinal element 3 and they can move relatively to the longitudinal element 3. In the present case per longitudinal element 3 at least two guide rollers 28 are arranged behind each other as seen on this longitudinal axis A. This has the advantage that the sliding element 4 cannot be pivoted with regard to the longitudinal guiding elements 3 but it can be moved along the longitudinal axis A.

The mounting element in the shape of the sliding element 4 has in the present embodiment the shape of a housing having two side faces 33 and a bottom and top face 34 both of which are connected to the side faces 33. The side faces 33, as well as the bottom face and the top face 34 limit an interior space 35 through which said arm 5 extends. The interior space 35 is open in longitudinal direction A. In the present case the guide rollers 28 are connected to the side faces 33. With regard to the other embodiment in which the mounting element is not a sliding element the mounting element can be provided in a similar structure apart from the guide rollers.

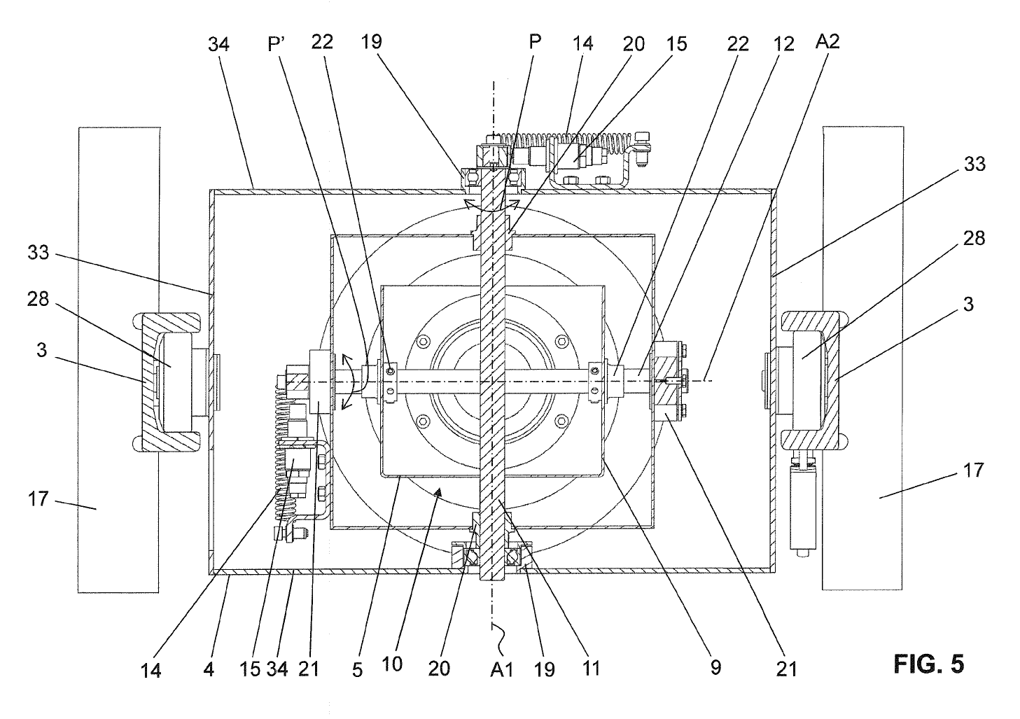

With the aid of FIG. 4 as well as of FIG. 5 showing a sectional view, the structure of the pivot element 10 will now be further explained. In the present embodiment the pivot element 10 is partly arranged in the interior space 35 as mentioned above. The pivot element 10 further comprises, apart from the first axle 11 and the second axle 12 a support structure 16.

The support structure 16 is via said first pivot axle 11 in connection with said sliding element 4 or the mounting element, respectively, such that the support structure 16 is pivotable around the first axis A1 with regard to the sliding element 4 or the mounting element, respectively. In other words the support structure 16 can be pivoted around the first axis A1. This pivot motion is symbolized by arrow P in FIG. 5. Further the bearing section 9 of the arm 5 is via said second pivot axle 12 in connection with said support structure 16 such that the bearing section 9 of the arm 5 is pivotable around said second axis A2 with regard to the support structure 16. This pivoting movement is shown by arrow P′ in FIG. 5. As the first axis A1 runs perpendicular to the second axis A2 it is possible to pivot the arm 5 in a cone-like space.

In the present embodiment both axles A1, A2 are provided as continuous axles. This means that they extend completely through the respective elements. In order to provide them as continues axles they are arranged at a distance to each other with regard to the longitudinal direction A.

The first pivot axle 11 is in the present embodiment connected to the support structure 16 with a fixed bearing 20. Thereby the support structure 16 comprises two fixed bearing through which the axle 11 extends. Furthermore there is pivot bearing 19 through which the first axle 11 is connected to the sliding element 4 or the mounting element, respectively. In the present case a first pivot bearing 19 is arranged in the bottom face and a second pivot bearing 19 is arranged the top face 34 of the sliding element 4 or the mounting element, respectively.

The second axle 12 is beared in a pivot bearing 21 which is a connection with the support structure 16. In the present embodiment there are two pivot bearings 21 arranged. Furthermore the second axle 12 is in connection with a fixed bearing 22 which connects the second axle 12 to the bearing section 9 of the arm 5.

In general the term “pivot bearing” is to be understood that there is a pivot motion between the axle and the bearing allowed. The pivot bearing 19, 21 itself is fixedly connected to the respective element, here sliding element 4 or the mounting element, respectively, with regard to the first axle 11 and to the support element 16 with regard to the second axle 12. Hence the respective axle 11, 12 is pivotable due to the arrangement of the pivot bearing 19, 21.

The term “fixed bearing” is to be understood as that there is no relative motion between the respective axle and the bearing allowed. Hence there is a fixed connection between the bearing and the axle. The fixed bearing 20, 22 itself is fixedly connected to the respective element, here support structure 16 with regard to the first axle 11 and to the bearing section 9 with regard to the second axle 12. Therefore with the fixed bearing the axle is in a fixed connection with the respective element to which the fixed bearing is connected.

With regard to FIG. 5 it can also be seen that the tension unit 14 and/or the damper unit 15 are arranged in connection with the pivot bearings 19, 21. Hence the respective units 14 act on the axle 11, 12 extending through the pivot bearing 19, 21.

Referring to all figures several further features of the actuation device 1 are explained below.

The longitudinal guiding element 3 is preferably part of a frame 17. The frame 17 comprises preferably fixing elements 18 so as to fix the frame 17 to an external element. The external element can be part of a building structure, such as a garage or a bus stop shelter. In the embodiment in which the mounting element is not the sliding element, the mounting element can be provided with said fixing elements. However, the actuation device can also be mounted on a bus or a car.

A channel 23 extends through the balance element 13 and the arm 5. The channel 23 is configured to receive a cable supplying energy to the connector 2 through an optional junction box 39 which is part of the connector. The cable as such is not shown. Furthermore a flexible cable guiding element 24 is connected to the rear section 8 of the arm 5 in the vicinity of the channel 23. This cable guiding element 24 serves to protect and to guide the cable into the channel 23. As it can be seen in FIG. 6 on each side one of said cable guiding element 24 is arranged.

Furthermore the actuation device 1 comprises an actuator 25 which acts on the sliding element 4 in order to move the sliding element 4 from the rear end 29 to the front end 30 of the longitudinal guiding element 3. The actuator 24 is in the present case shown as belt transmission 36.

The electrical connector 2 comprises in the present case a contact section 26 and a deflection section 27. The contact section 26 is here protected by a protection cover 37 which can be moved along the connector 2 against a spring element 38. When the protection cover 37 is moved then access to the electrically conductive part of the contact section 26 can be provided. The spring element 38 serves to maintain the position of the protection cover 37 such that the electrically conductive part of the contact section 26 is covered. The deflection section 27 is arranged between the connection interface 7 and the contact section 26. With the deflection 27 it is possible to compensate a slight misalignment between the contact section 26 and the plug side to which the contact section 26 shall be connected. Hence it is possible to deflect the contact section 26 with regard to the arm axis B.

The connector 2 as well as the deflection section 27 is preferably provided according to the connector system according to EP 2 393 165. The technical teaching of this publication is herewith incorporated by reference.

LIST OF REFERENCE SIGNS

| | |
|---|---|
| 1 | actuation device |
| 2 | connector |
| 3 | longitudinal guiding element |
| 4 | sliding element, mounting element |
| 5 | arm |
| 6 | front section |
| 7 | connection interface |
| 8 | rear section |
| 9 | bearing section |
| 10 | pivot element |
| 11 | first pivot axle |
| 12 | second pivot axle |
| 13 | balance element |
| 14 | tension unit |
| 15 | damper unit |
| 16 | support structure |
| 17 | frame |
| 18 | fixing elements |
| 19 | pivot bearing |
| 20 | fixed bearing |
| 21 | pivot bearing |
| 22 | fixed bearing |
| 23 | channel |
| 24 | flexible cable guiding element |
| 25 | actuator |
| 26 | contact section |
| 27 | deflection section |
| 28 | guide rollers |
| 29 | rear end |
| 30 | front end |
| 31 | spring |
| 32 | lever |
| 33 | side face |
| 34 | bottom face/top face |
| 35 | interior space |
| 36 | belt transmission |
| 37 | protection cover |
| 38 | spring |
| 39 | junction box |
| 40 | telescopic guide |
| A1 | first axis |
| A2 | second axis |
| A | longitudinal axis |
| B | arm axis |
| P | pivot movement |
| P′ | pivot movement |
| Z | arrow |

1. An actuation device for a connector comprising
a mounting element,
an arm extending along an arm axis, the arm having a front section with a connection interface configured to receive the connector, a rear section, and a bearing section between the front section and the rear section,
a pivot element which is in connection with the bearing section of the arm with the mounting element so as to connect the arm pivotably to the mounting element, wherein the pivot element comprises a first pivot axle allowing a first pivot movement around a first axis and a second pivot axle allowing a second pivot movement around a second axis, wherein the first axis and the second axis are perpendicular to each other,
and
a balance element which is connected to or provided at the rear section of the arm configured to balance the arm regarding a movement around at least one of the first and second pivot axles.

2. The actuation device according to claim 1, further comprising at least one longitudinal guiding element extending in a direction of a longitudinal axis, wherein the mounting element is a sliding element which is in a connection with the at least one longitudinal guiding element such that the sliding element is slideable relative to the at least one longitudinal guiding element or slideable by the at least one longitudinal guiding element in the direction of the longitudinal axis, wherein the first axle and/or the second axle are perpendicular to the longitudinal axis.

3. The actuation device according to claim 1, wherein the balance element has a weight which allows balancing of the arm between the front section and the rear section around the bearing section.

4. The actuation device according to claim 1, wherein each of the pivot axles are connected to a tension unit providing a tension force in order to maintain the arm in an initial position and/or wherein each of the pivot axles are connected to a damper unit providing a damping force against a movement of the arm around the first axis and the second axis.

5. The actuation device according to claim 2, wherein exactly two longitudinal guiding elements are arranged parallel and at a distance to each other.

6. The actuation device according to claim 2, wherein the sliding element comprises for at least one of the longitudinal guiding elements at least two guide rollers, wherein the guide rollers interact with the longitudinal guiding element.

7. The actuation device according to claim 2, wherein the pivot element further comprises a support structure,
wherein the support structure is via the first pivot axle in connection with the mounting element or the sliding element, respectively, such that the support structure is pivotable around the first axis with regard to the mounting element or the sliding element, respectively,
and
wherein the bearing section of the arm is via the second pivot axle in connection with the support structure such that the bearing section is pivotable around the second axis with regard to the support structure (16).

8. The actuation device according to claim 7,
wherein the first pivot axle is pivotably mounted in a pivot bearing and fixedly mounted in a fixed bearing, which pivot bearing is part of the support structure and which fixed bearing is part of the mounting element or the sliding element, respectively, or which pivot bearing is part of the mounting element or the sliding element, respectively, and which fixed bearing is part of the support structure and/or
wherein the second pivot axle is pivotably mounted in a pivot bearing and fixedly mounted in a fixed bearing, which pivot bearing is part of the support structure and which fixed bearing is part of the bearing section of the arm or which pivot bearing is part of the bearing section of the arm and which fixed bearing is part of the support structure.

9. The actuation device according to claim 8, wherein at least one of the tension unit and the damper unit are arranged in connection with the pivot bearings.

10. The actuation device according to claim 2, wherein the at least one longitudinal guiding element is part of a frame comprising fixing elements configured to fix the frame to an external element.

11. The actuation device according to claim 1, wherein a channel extends through the balance element and the arm, which channel is configured to receive a cable supplying energy to the connector.

12. The actuation device according to claim 11, wherein a flexible cable guiding element is connected to the rear section of the arm in the vicinity of the channel.

13. The actuation device according to claim 2, further comprising an actuator which acts on the sliding element in order to move the sliding element along the longitudinal axis.

14. A connection system comprising an actuation device according to claim 1, and an electrical connector which is connected to the front sections of the arm.

15. The connection system according to claim 14, wherein the electrical connector comprises a contact section configured to be received by a socket and a deflection section configured to compensate an angular misalignment between the contact section and the socket.
